(19) United States
(12) Patent Application Publication
(10) Pub. No.: US 2025/0267178 A1
(43) Pub. Date: Aug. 21, 2025

(54) CROSS-PLATFORM IMPLEMENTATION OF CLOUD-BASED APPLICATIONS UTILIZING NOODL PROGRAMMING

(71) Applicant: AiTmed, Inc., Anaheim, CA (US)

(72) Inventor: Hongtao Yu, Rolling Hills, CA (US)

(21) Appl. No.: 18/858,557

(22) PCT Filed: Apr. 12, 2021
(86) PCT No.: PCT/US2021/026796

§ 371 Date: Oct. 21, 2024

Related U.S. Application Data
(60) Provisional application No. 63/132,388, filed on Dec. 30, 2020.
(60) Provisional application No. 63/171,917, filed on Apr. 7, 2021.
(60) Provisional application No. 63/172,339, filed on Apr. 8, 2021.

(51) Int. Cl. H04L 65/403; G06F 21/62; H04L 67/10

(52) U.S. Cl. CPC H04L 65/403; G06F 21/629; H04L 67/10

(57) ABSTRACT

An edge computing operating system (ECOS) computing system, utilizing an ECOS computing device implements cloud-based applications. The cloud-based applications are implemented based on one or more user-defined attributes, or schema, provided by users of the ECOS computing system. The cloud-based applications are implemented by the ECOS system using one or more neuron organic object data language (NOODL) extension files in combination with one or more NOODL data objects created using the received user-defined attributes, or schema. The NOODL extension files generate a mapping of a computer application usable on a user's device. Secure on-line communications are provided by the implemented applications in accordance with applicable privacy laws.

### CROSS-REFERENCE TO RELATED APPLICATIONS

This application claims the benefit of U.S. Provisional 62/132,388, filed Dec. 30, 2020, U.S. Provisional 63/171,971, filed Apr. 7, 2021, and U.S. Provisional 63/172,339, filed Apr. 8, 2021, which are hereby incorporated by reference.

### FIELD OF THE INVENTION

The present invention relates to implementing cloud-based applications between multiple entities, and, more particularly, implementing cloud-based applications cross-platform and thereby providing secure on-line communications between endpoints in accordance with compliance standards.

### BACKGROUND

Turing completeness is a statement on the expressive power of a programming language, or an arbitrary computation machine. Turing machines are known to be the most powerful computation machines that exist. Turing completeness of a programming language means that anything that can be computed at all can be computed by that language. Turing completeness is an important feature of any programming language, since it allows the user to express or computer what the user wants. In 1952, it was proposed to use so-called recursive functions for computations on natural numbers as the equivalent definition of the Turing complete computations. Typically, the recursive functions are inductively defined and consists of basic functions (e.g., a set of functions that always return the number zero (0), a set of functions that select a component out of tuple, and the successor function, which adds one (1) to any given natural number). More complex functions can be constructed by base functions using different schemas (e.g., a composition of functions or primitive recursion, which allows to define the value of a function for some number n based on the value this function returns for its predecessor n−1. Most programming languages are Turing complete, such as widely used general-purpose languages (e.g., C, C++, Java, Pascal, Python, etc.). Unintentional Turing complete software or video games exist, such as PowerPoint® or Minecraft®, for example.

Common object-oriented programming languages, such as Java or C++, rely on defining classes for creating objects. Further, certain behaviors may be defined based on these defined classes. Conventional programming languages lack the ability to do actions beyond the design of the class. Further, conventional programming languages are limited to finite computer algorithms (e.g., a Turing machine).

### BRIEF SUMMARY OF THE INVENTION

The present embodiments may relate to, inter alia, systems and methods for providing cross-platform implementation of cloud-based applications.

In an exemplary embodiment, systems and methods may be provided for an edge computing operating system (ECOS) configured to implement cloud-based applications, the ECOS comprising, at least one ECOS computing device including a memory and a processor, and a plurality of user devices implementing at least one application in communication with the at least one ECOS computing device, wherein ones of the plurality of user devices receive NOODL code in response to an identifying attribute of a user device.

In one aspect, an edge computing operating system (ECOS) computing device including at least one processor in communication with a memory device may be provided. The at least one processor may be configured to provide at least one ECOS code library accessible to at least one of the plurality of user device.

The ECOS computing device may include additional, less, or alternate actions, including those discussed elsewhere herein.

The computer-implemented method may be implemented by an edge computing operating system (ECOS) computing device including at least one processor in communication with a memory device. The computer-implemented method may include NOODL code for unifying communications between HTML, CSS and java script code and facilitating communication between a user interface operable on a first operating system and a database operable with a second operating system. The computer-implemented method may include additional, less, or alternate actions, including those discussed elsewhere herein.

The present invention may provide an edge computing operating system (ECOS) configured to implement cloud-based applications, the ECOS comprising, at least one ECOS computing device including a memory and a processor, and a plurality of user devices implementing at least one application in communication with the at least one ECOS computing device, wherein ones of the plurality of user devices receive NOODL code in response to an identifying attribute of a user device.

The present invention may provide a method for establishing secure communications between a plurality of entities in accordance with one or more compliance standards. In at least one embodiment, two of the plurality of entities may include a patient and a provider, such as a doctor, for example. Via a one-click operation, such as a selection of a web link, the patient and the doctor may be connected to one another via a secure communication link. The connection may provide a virtual exam room for the patient and the provider. The virtual exam room may include audio and video capabilities. Further, the virtual exam room may provide secure access to health records data. In some embodiments, the virtual exam room is established in accordance with applicable compliance laws or standards, such as HIPAA compliance laws.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a simplified functional block diagram of an edge computing operating system (ECOS) system in accordance with the embodiments of the disclosed invention;

FIG. 2 illustrates an exemplary client computing device that may be used with the computing system illustrated in FIG. 1;

FIG. 3 illustrates an exemplary server system that may be used with the computing system illustrated in FIG. 1;

FIGS. 4A-4J illustrate exemplary basic operations by a language used by the ECOS system illustrated in FIG. 1;

FIGS. 5A-5H illustrate exemplary organic operations by a language used by the ECOS system illustrated in FIG. 1;

FIG. 6 illustrates an exemplary method 600 for cross-platform implementations of cloud-based applications using the ECOS system illustrated in FIG. 1;

FIG. 7 illustrates an exemplary method 700 for a sign-on process for accessing the ECOS system illustrated in FIG. 1 using asymmetric keys;

FIG. 8 illustrates an exemplary method 800 for initial user registration flow with the ECOS system illustrated in FIG. 1;

FIG. 9A illustrates another exemplary system 900A for providing access to a PHI database to one or more system users;

FIG. 9B illustrates another exemplary system 900B for providing secure communications between a patient and an access provider;

FIGS. 10A and 10B illustrate exemplary methods 1000A and 1000B for providing system registration with the ECOS system illustrated in FIG. 1;

FIG. 11 illustrates an exemplary method 1100 for registration of a patient with the ECOS system illustrated in FIG. 1;

FIG. 12 illustrates an exemplary method 1200 for a one-click process for a virtual session using the ECOS system illustrated in FIG. 1;

FIG. 13 illustrates an exemplary method 1300 for a one-click process for a provider to initiate a virtual visit using the ECOS system illustrated in FIG. 1; and

FIG. 14 illustrates an exemplary method 1400 for a virtual meeting using the ECOS system illustrated in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for mapping computer applications among disparate devices. In some embodiments, the systems and methods described herein may include connecting a UI/UX design with a frontend application, a backend data-model design, and or a human-machine information exchange input-output. Additionally, or alternatively, a single computing language may uniform multiple computer languages at a high level of abstraction. In one exemplary embodiment, the process may be performed by an Edge Computing Operating System (ECOS) computing system. Additionally, or alternatively, the process may be performed using a Neuron Organic Object Description Language (NOODL).

### Neuron Organic Object Description Language (NOODL)

In some embodiments a data definition language may be defined as a human-readable data-serialization language for the storing and transmitting of data files. For example, the data definition language may be a YAML, known as Yet Another Markup Language or YAML Ain't Markup Language. The data definition language described herein will be referred to as a Neuron Organic Object Description Language, or NOODL. A NOODL may define its own set of vocabulary and may include organic operations in addition to, or in combination with, basic operations. Further, it may also define its own special syntax. In some embodiments, a NOODL may use key-value pairs to define hierarchical data objects. Additionally, objects may be define and can either be inherited or extended. In some embodiments, the value of an object may be changed. A key that may be provided at the beginning of a line may be denoted as a root-level object. In a NOODL, everything may be based on an object and the interaction, described herein and below, differentiates NOODL from other common programming languages.

As described below, systems and methods described herein may include a NOODL that includes an evolutionary capability. More than a programming language, NOODL is an organic combination between a programming language and a biological system. NOODL, with the capability to evolve, in some embodiments, becomes a bionic system. For example, an object may behave like a DNA sequence where an expression may be dependent on the environment or another object it may encounter.

In some embodiments, the disclosed systems and methods may include a Neuron Organic Object Description Language (NOODL), a Yet Another Markup Language (YAML), that is formatted as a data definition language. For example, as a language, it may define its own set of vocabulary and may also include its own special syntax. In some embodiments, the NOODL may use a key-value pair to define hierarchical data objects. In a NOODL, for example, only objects may be defined and may be inherited or extended. In some embodiments, the value of an object, for example, may be changed. Additionally, at the beginning of a line of an object, a key may be provided and denoted as a root-level object. In a NOODL, as objects interact, the objects may be adaptive and may be naturally changed based on the information that the objects may carry. Adaptive objects described herein may, for example, enable artificial intelligence (AI) behavior.

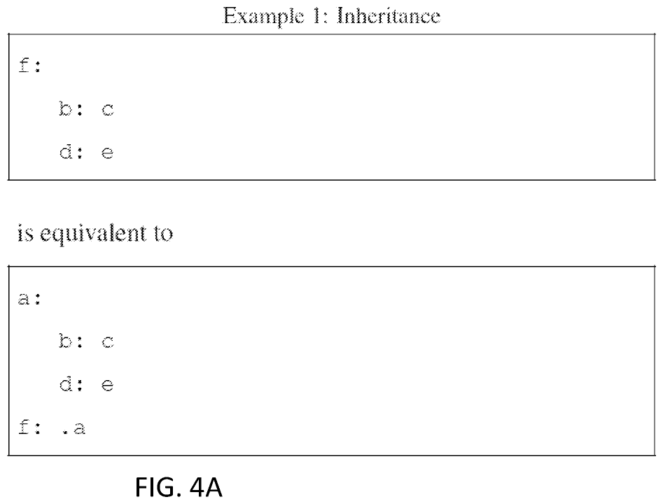

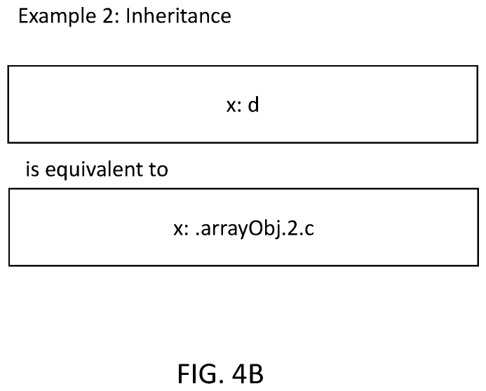

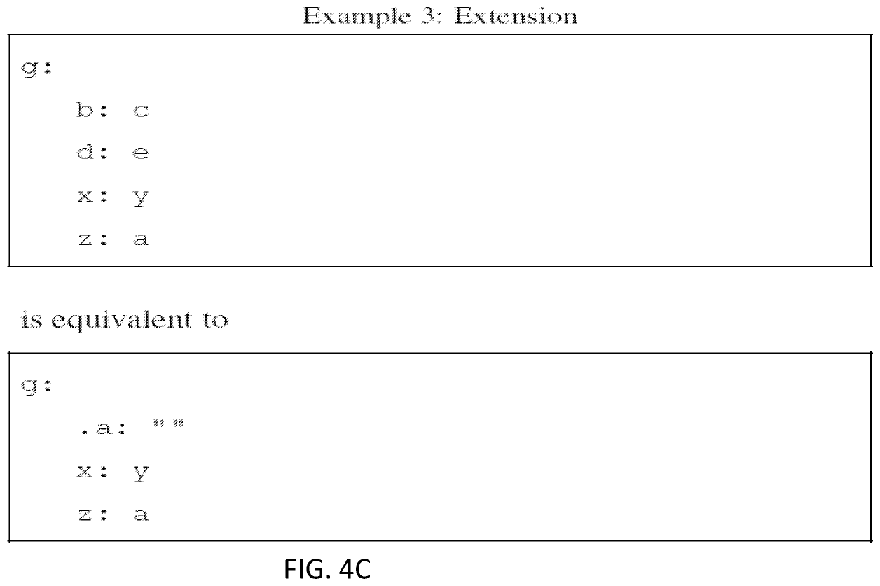

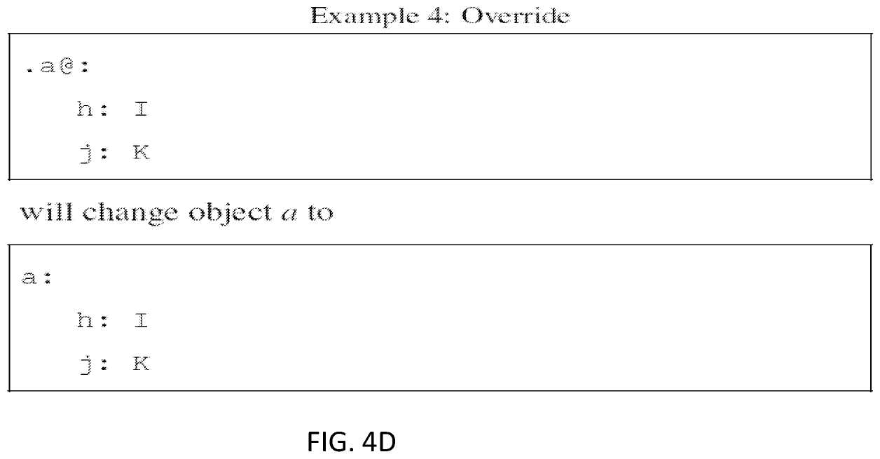

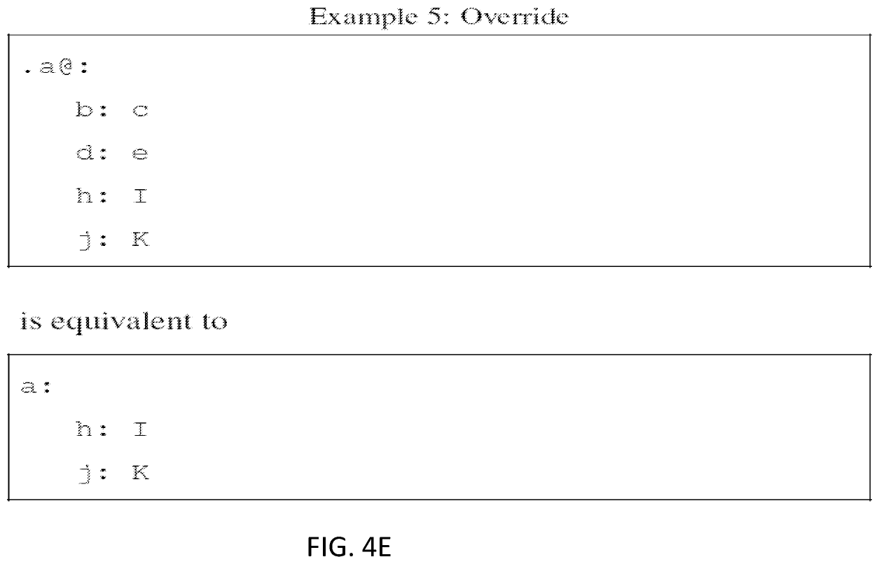

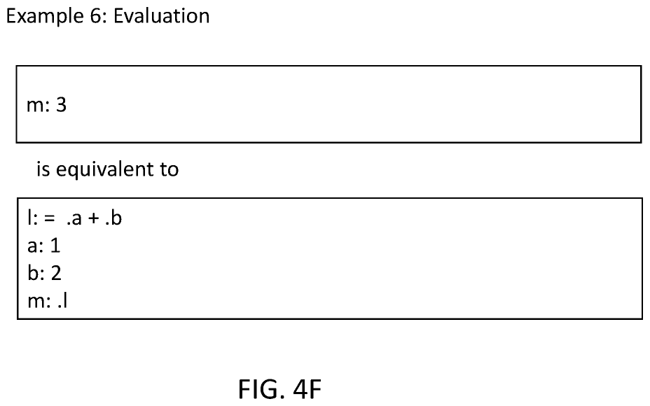

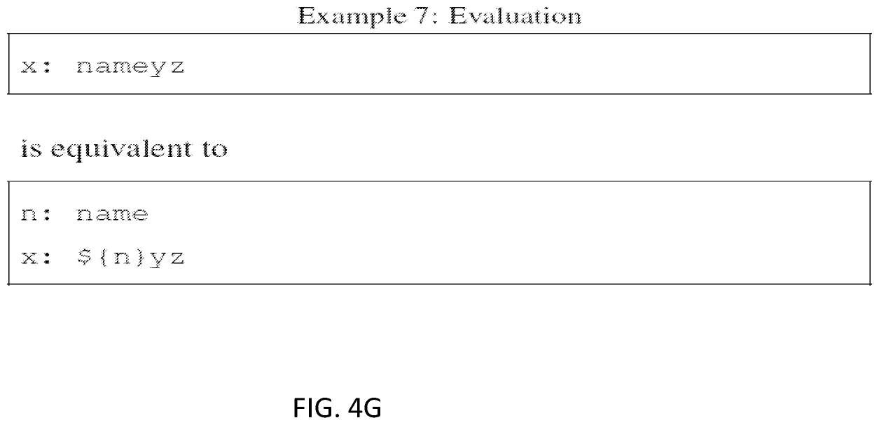

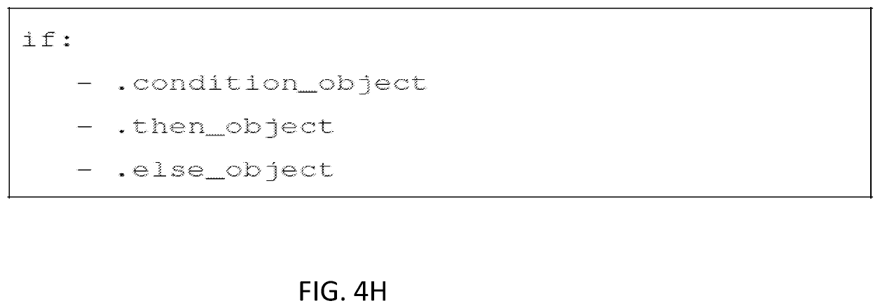

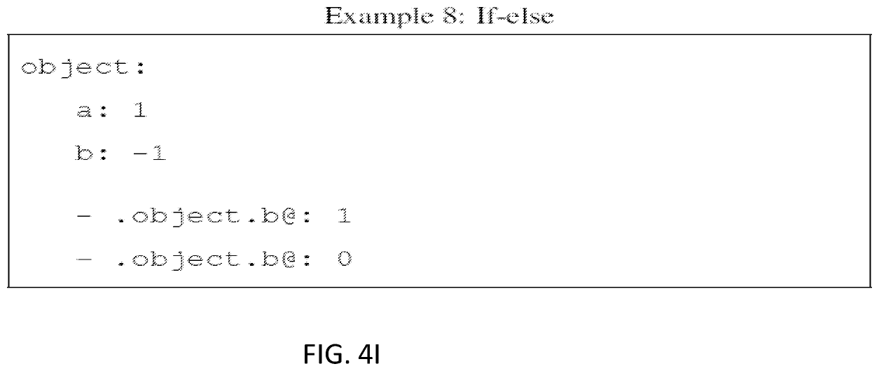

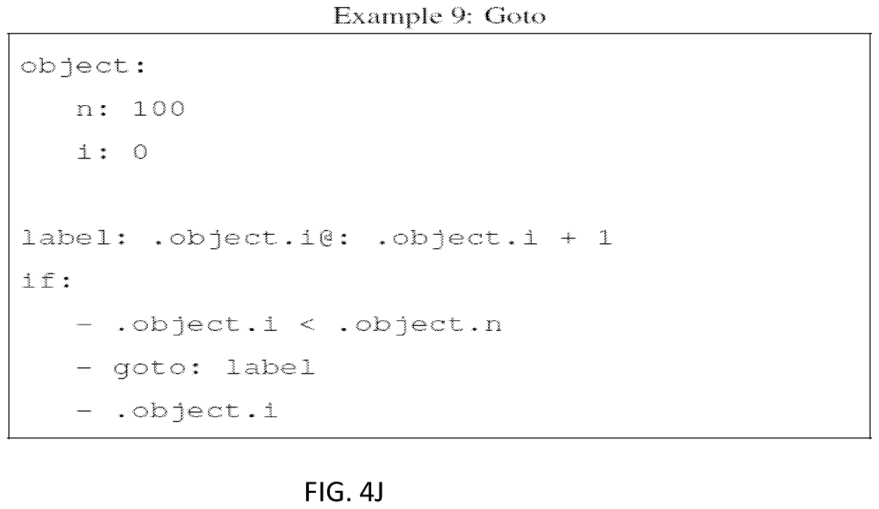

In some embodiments, the disclosed systems and methods may include a Neuron Organic Object Description Language (NOODL) that may include several useful basic operations in addition to one or more organic operations. FIGS. 4A-4J illustrate exemplary basic operations of the disclosed NOODL Language. These basic operations may include, but are not limited to, inheritance, extension, override, and evaluation. The organic operations may include, but are not limited to, evolve, elite, emit, and convolve. Additional operations may be utilized without departing from the spirit and scope of the disclosed embodiments.

In some embodiments, in view of FIGS. 4A and 4B, an inheritance operation may enable the copying of all or part of an object into another object. For example, attributes of an object may be inherited using an operator for syntax, such as a dot operator (.), for example. Inheritance saves not only time, but also space. Additionally, inheritance may be enabled from a root level to its child descendants. Array objects may be defined using certain syntax, such as a dash operator (-), or the like. Additionally, or alternatively, the inheritance of an element of an array object may be accomplished by using a corresponding subscript number of a member.

An extension operation, as illustrated in FIG. 4C, may enable the expansion of an object. In some embodiments, an extension operation may be used in combination with an inheritance operator. Example extension operator syntax, such as a colon (:), may be used, for example. Additionally or alternatively, an object a may be created by extension of another object, such as object b, where object a is created having all of the same attributes set forth by object b. In the example shown in FIG. 4C, an object g may be created by extension from object a.

In yet another example embodiment as shown in FIG. 4D, another basic operation, called an override, may be used to allow modifications to one or more existing objects. In FIG. 4D, the override operation may be exploited to make changes to an existing object a. Additionally, an override operation may be used in combination with an inheritance operation, as shown in FIG. 4E. A key difference between an override operation and an extension operation lies in that whether a reference object has changed. For example, if a new object is to be created without a need to change a reference, then an extension operation should be used. Alternatively, if an object is to be completely changed, then the basic operation of override should be used instead of an extension operation.

In another embodiment, another basic operation, called an evaluation, may be implemented by a NOODL. An evaluation may be used in combination with or as part of the one or more of the other basic operations, such as an inheritance operation. Additionally, an evaluation operation may be utilized to evaluate numerical values. For example, an evaluation may use “=” syntax. An example of this is shown in FIG. 4F. Additionally, or alternatively, an evaluation operation may be utilized to evaluate string or character values, using syntax that may include a dollar sign ($) and/or a curly bracket ({ }), or the like. An example evaluation operation for string or character values is shown in FIG. 4G.

Implementations of a NOODL may include one, some, or all of the basic operations described herein. Further, NOODL implementations may include basic operations not described herein and it is understood that the operations set forth are merely meant to illustrate example embodiments of the disclosure.

Even further, a NOODL may include one or more loop operations, such as if-else loop operations or goto operations, as shown in FIGS. 4H-J. If-else loop operations, or conditional statements, may be used to specify new conditions for one or more objects based on one or more defined conditions. Alternatively, goto operations, or goto commands, may be utilized to, for example, as an unconditional change or jump action to other points within programming code.

The proof of Turing completeness of NOODL is similar to the proof of any common programming language by showing the μ-recursion capability. It is understood that the other methods of proofing may be implemented without departing from the spirit and scope of the disclosed embodiments.

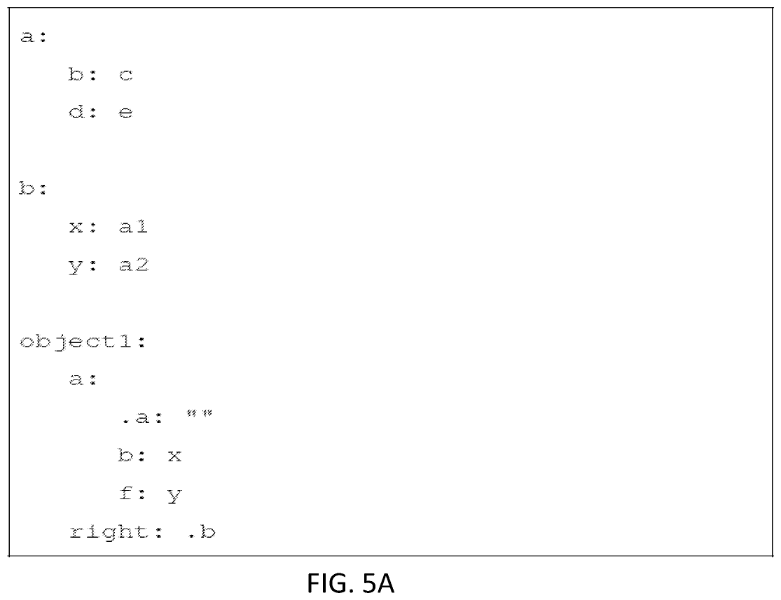

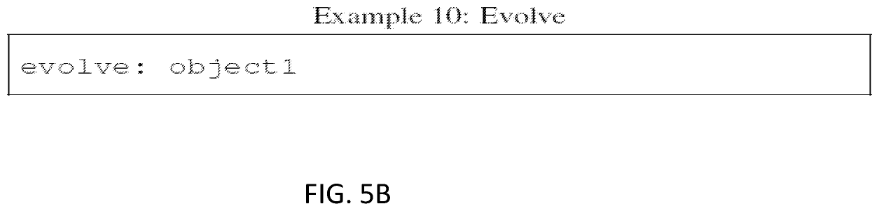

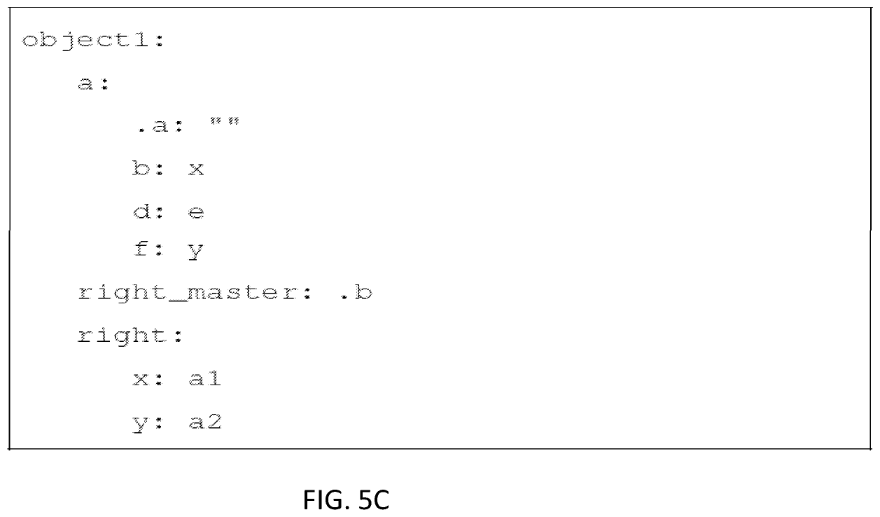

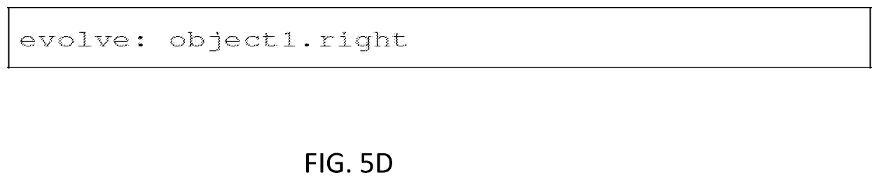

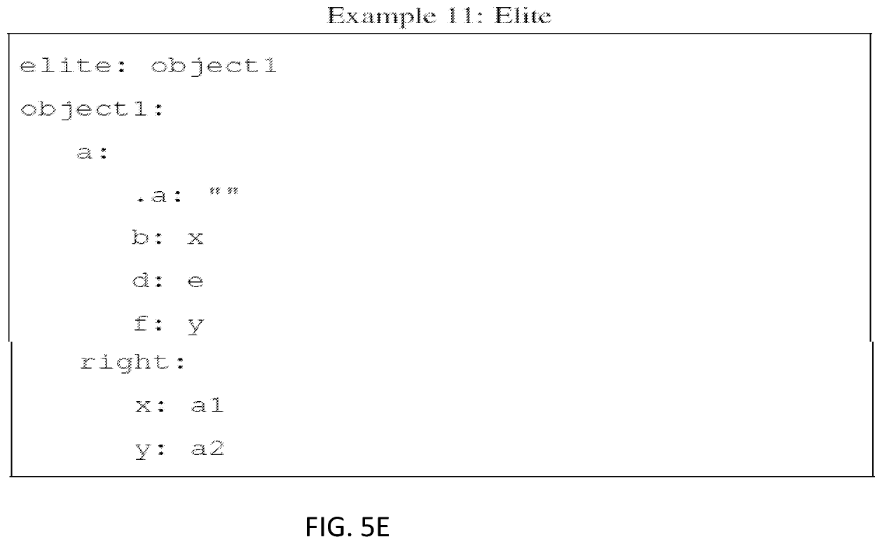

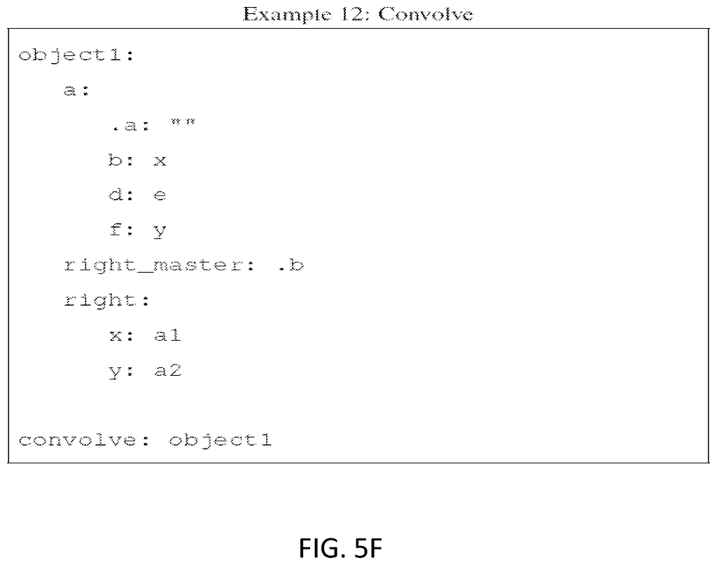

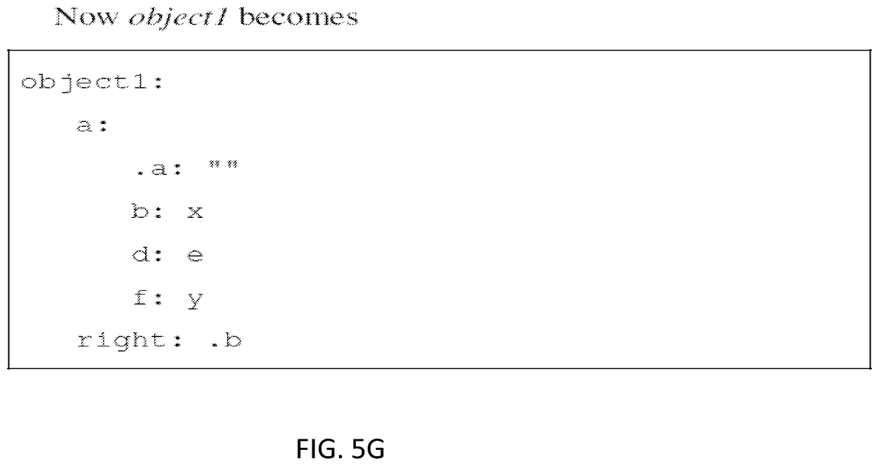

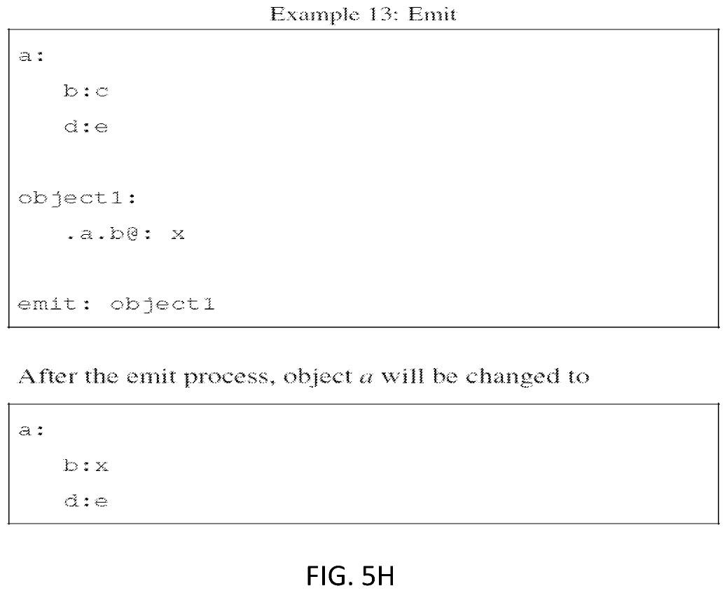

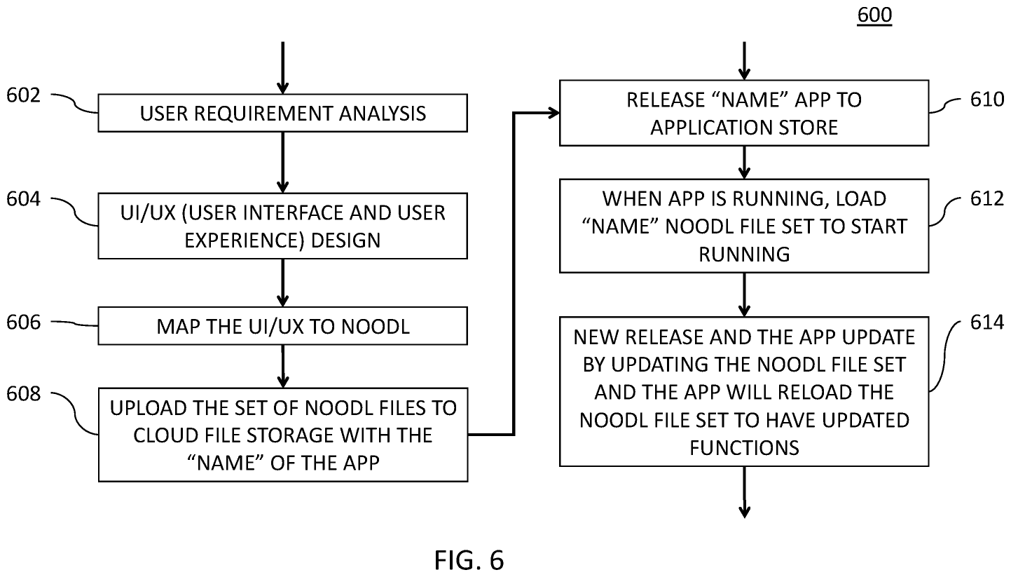

FIGS. 5A-5H illustrate organic operations of the disclosed NOODL Language. In some embodiments, the disclosed systems and methods may include a NOODL Language that may include several organic operations in addition to, or in combination with, the one or more basic operations illustrated in FIGS. 4A-4J and described herein and above. Organic operations, for example, may provide an organic combination between a programming language and a biological system. In a complete cycle of organic operations, an implementation of a NOODL may become a bionic system that may mimic the whole life of a biological creature. For example, the life of an object (i.e., the complete cycle of organic operations), is similar to the process of egg-chicken-hen-egg.

In some embodiments, organic operations may include, but are not limited to, evolve, elite, emit, and convolve. Additional operations may be utilized without departing from the spirit and scope of the disclosed embodiments. Additionally, or alternatively, the four organic operations of evolve, elite, emit, and convolve, may represent a complete lifecycle. For example, the implementation of a NOODL, or implementation of a NOODL object, may undergo a complete cycle of the four organic operations. Additionally, or alternatively, a NOODL object may include less, or even more, additional operations, such as a combination of either one or more basic operations, one or more organic operations, or a mixture of both basic and organic operations, for example.

In an example embodiment, a first organic operation, as illustrated by FIG. 5A, may be referred to as an evolve operation. An evolve operation for a NOODL may, for example, be compared to an evolution from an egg to a chicken. In simple terms, the evolve operation de-references all pointers and may make a deep copy of an object. Additionally, an evolve operation may be considered an organic operation that is an information absorbing procedure. Typically, the evolve operation may be implemented by using an evolve method. In some embodiments, a part of an object, instead of the entire object, may be evolved.

An example evolve operation is shown in FIG. 5A using three objects, a, b, and object1. The evolve command may be run by using the syntax of FIG. 5B, for example. FIG. 5C shows what object1 becomes. In FIG. 5C, .b is de-referenced, and the pointer itself is still kept in the right_master. The value or attributes of .b are copied to right. Subsequently, when b has any changes, its change may lead to the change of object1 if object1 evolves again. A part of an object may be evolved. The same result may be retrieved through the example syntax shown in FIG. 5D.

Further, with respect to the organic operation of an evolve method, and continuing with the egg/chicken analogy, the chicken, or object, still as the ability to evolve again, since the pointer is still kept in the master key. In some embodiments, during the process of an evolve operation, any override operations may be omitted. Override operations may be executed in an emit method, described below.

In an example embodiment, a second organic operation may be referred to as an elite operation. An example is shown in FIG. 5E. An elite operation for a NOODL may, for example, may be compared to the evolutionary process of a chicken to a hen. In an elite organic operation, the process may remove any and all master pointers and only preserve their values. For an elite process, an object, such as a NOODL object, may mature but cannot evolve again.

In an example embodiment, a third organic operation may be referred to as a convolve operation. An example convolve operation is shown in FIGS. 5F and 5G. A convolve operation for a NOODL object may, for example, may be compared to the process of a hen to an egg. In other words, a convolve organic operation may be the exact reverse of an evolve operation. In some embodiments, a convolve operation removes all object attributes but preserves the master pointers.

In yet another example embodiment, a fourth organic operation may be referred to as an emit operation. An example emit operation is shown in FIG. 5H. An emit operation for a NOODL object may, for example, cause certain information to be emitted during a process. For example, any changes to an object may be emitted to the environment through an emit organic operation.

In some embodiments of the disclosed systems and methods, a NOODL implementation may be applied to a machine learning model. For example, a machine learning model may be used to detect the species of animals in an image. Further, the model may be pre-trained and saved. When a new object containing a new image encounters the pre-trained image, an evolution may happen to both images. First, a prediction of the possible species may occur and may then be applied to the machine learning model. Second, if an image carries a true label of a species, such as one given by a human or an expert, the model image data may absorb the new data and the model may be re-trained and updated. Errors may be corrected in the same manner if predictions are found to be incorrect.

In some embodiments, a NOODL may generate, or map, a computer application for a specific device, such as an Android device, an Apple iOS device, or a desktop device, such as macOS or Windows. Further, a NOODL may connect UI/UX design with a frontend application, a backend data-model design, and/or a Human-Machine Information Exchange input-output. Additionally, a NOODL may uniform HTML, CSS or even Javascript at a higher level of abstraction.

### Exemplary Computing System for Cross-Platform Implementation of Cloud-Based Applications

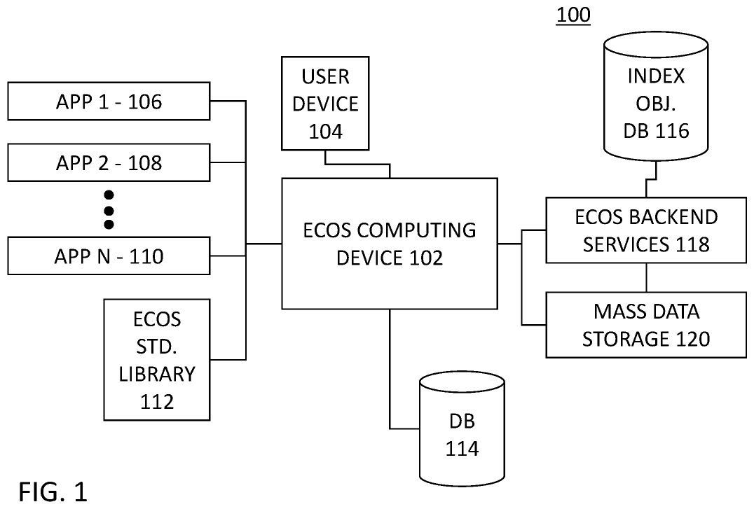

FIG. 1 illustrates a block diagram 100 of an exemplary computing network architecture. In some embodiments, computing network architecture 100 may include, for example, a cloud-computing architecture.

An ECOS, or Edge Computing Operating System for an Information Object, may modularize and standardize one or more frontend, or edge, computing function blocks. In some embodiments, a simple server implementation with a combination of SQL and non-SQL data storage may be provided. In some instances, a server may be limited for data storage, data retrieval, and data exchange. The server may be expected to maintain not only data relation but also data integrity. Additionally, an ECOS may provide clients, or users, with so-called WYS-WYG, or What You Save and What You Get. Additionally, or alternatively, a data scheme may be defined by clients, or users, and used by the clients, or users, in the frontend.

In one implementation example, methods and systems may be provided for cross-platform implementation of cloud-based applications. A client may provide one or more elements for user requirement analysis that may then be applied to the design of a user interface and a user experience (i.e. UI/UX). This UI/UX may then be mapped to a NOODL and a series of NOODL files may be created and stored. In some embodiments, the NOODL files may be stored in a cloud file storage and follow a defined naming convention. For example, NOODL files may be organized or associated with a certain application, or app. An app that is loaded into an app store, such as a mobile device application store, may be downloaded to a mobile device. When the app is run by the mobile device, for example, the one or more NOODL files associated with the app may be loaded onto the mobile device from the cloud file storage location. Additionally, app updates may be accomplished by using the NOODL file sets and may be reloaded in response to the NOODL file sets.

FIG. 1 depicts an exemplary ECOS computing system 100. ECOS computer system 100 may include an ECOS computing device 102 (also referred to herein as ECOS server or ECOS computer device). ECOS computing device 102 may include a database server. ECOS computing device 102 may be in communication with, for example, one or more of a database 114, one or more user devices 104, one or more applications 106, 108, 110, ECOS standard library 112, index object database 116, backend services 118, and/or mass data storage 120. While a single user device is shown with respect to user device 104, it is understood that multiple user devices may be provided.

In the exemplary embodiment, user device 104 may be a computer that includes a web browser or a software application, which enables user device 104 to access remote computer devices, such as ECOS computing device 102, using the Internet or other network. More specifically, user device 104 may be communicatively coupled to ECOS computing device 102 through many interfaces including, but not limited to, at least one of the Internet, a network, such as the Internet, a local area network (LAN), a wide area network (WAN), or an integrated services digital network (ISDN), a dial-up-connection, a digital subscriber line (DSL), a cellular phone connection, and a cable modem. User device 104 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

Applications 106, 108, 110 may be accessed by user device 104 via ECOS computing device 102. While being accessed by user device 104 via ECOS computing device 102, user device 104 may retrieve information from applications 106, 108, 110 and/or send information to applications 106, 108, 110. Such information that may be received/sent may include, for example, medical records and/or other medical information.

When establishing connection with applications 106, 108, 110 via ECOS computing device 102, a sign-in process may be used to verify user device 104. Such a sign-in process may use a combination of private keys, public keys, and/or one or more key signatures, such as the sign-in processes detailed herein and below.

ECOS computing device 102 may be communicatively coupled to database 114 that stores data. In one embodiment, database 114 may include medical data associated with users, healthcare contact information, etc. In the exemplary embodiment, database 114 may be stored remotely from ECOS computing device 102. In some embodiments, database 114 may be decentralized. In the exemplary embodiment, a user may access database 114 and/or ECOS computing device 102 via user device 104.

ECOS computing device 102 may be communicatively coupled to ECOS backend services 118 and mass data storage 120. Additionally, ECOS backend services 118 may be communicatively coupled to mass data storage 120 and index object database 116.

ECOS backend services 118 may provide general services and maintenance to ECOS computing device 102, index object database 116, and/or mass data storage 120. Mass data storage 120 may store information relayed from ECOS computing device 102 and/or ECOS backend services 118. Mass data storage 120 may also provide information to ECOS computing device 102 and/or ECOS backend services 118.

ECOS computing device 102 may be communicatively coupled to ECOS standard library 112. ECOS standard library 112 may also be communicatively coupled to applications 106, 108, 110.

### Exemplary Client Computing Device

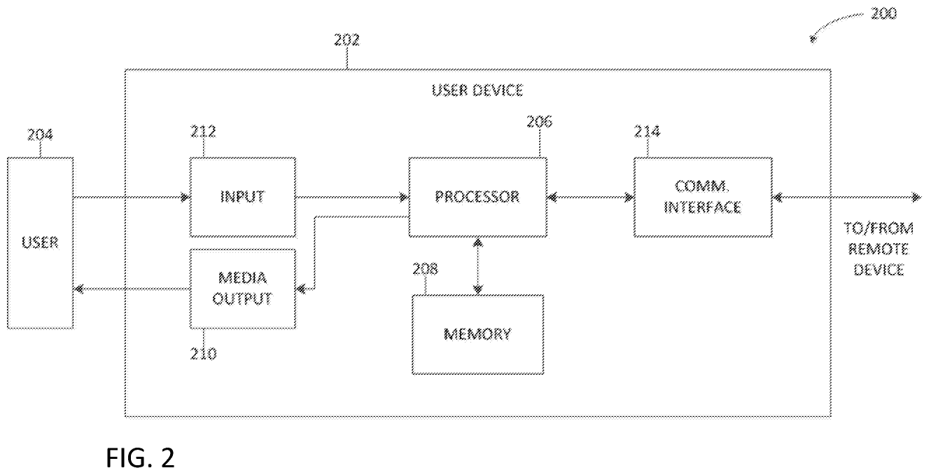

FIG. 2 illustrates a block diagram 200 of an exemplary client computing device 202 that may be used with the computing device 102 shown in FIG. 1. Client computing device 202 may be, for example, at least one of user device 104 (shown in FIG. 1).

Client computing device 202 may be accessible to a user 204, such as an end user accessing one of Apps 106-110 of FIG. 1 via a user device. Device 202 may include a processor 206 for executing instructions. In some embodiments, executable instructions may be stored in a memory area 208. Processor 206 may include one or more processing units (e.g., in a multi-core configuration). Memory area 208 may be any device allowing information such as executable instructions and/or other data to be stored and retrieved. Memory area 208 may include one or more computer readable media.

In one or more exemplary embodiments, client computing device 202 may also include at least one media output component 210 for presenting information to a user 204. Media output component 210 may be any component capable of conveying information to user 204. In some embodiments, media output component 210 may include an output adapter such as a video adapter and/or an audio adapter. An output adapter may be operatively coupled to processor 206 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones).

Client computing device 202 may also include an input device 212 for receiving input from a user 204. Input device 212 may include, for example, a keyboard, a pointing device, a mouse, a stylus, a touch sensitive panel (e.g., a touch pad or a touch screen), a gyroscope one or more sensors or an audio input device. A single component, such as a touch screen, may function as both an output device of media output component 210 and an input device of input device 212.

Client computing device 202 may also include a communication interface 214, which can be communicatively coupled to a remote device, such as ECOS computing device 102, shown in FIG. 1. Communication interface 214 may include, for example, a wired or wireless network adapter or a wireless data transceiver for use with a mobile phone network (e.g., Global System for Mobile communications (GSM), 3G, 4G, or Bluetooth) or other mobile data networks (e.g., Worldwide Interoperability for Microwave Access (WIMAX)). The systems and methods disclosed herein are not limited to any certain type of short-range or long-range networks.

Stored in memory area 208 may be, for example, computer readable instructions for providing a user interface to user 204 via media output component 210 and, optionally, receiving and processing input from input device 212. A user interface may include, among other possibilities, a web browser or a client application, such as a mobile application. Web browsers may enable users, such as user 204, to display and interact with media and other information typically embedded on a web page or a website.

Memory area 208 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are exemplary only, and are thus not limiting as to the types of memory usable for storage of a computer program.

### Exemplary Server Computing Device

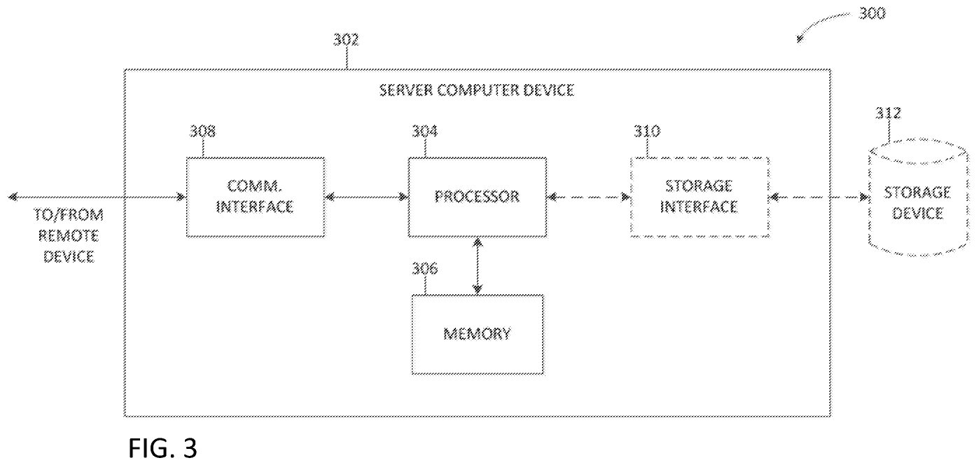

FIG. 3 depicts a block diagram 300 showing an exemplary server system 302. Server system 302 may be, for example, computing device 102, a database server, or back end server 118 (shown in FIG. 1).

In exemplary embodiments, server system 302 may include a processor 304 for executing instructions. Instructions may be stored in a memory area 306. Processor 304 may include one or more processing units (e.g., in a multi-core configuration) for executing instructions. The instructions may be executed within a variety of different operating systems on server system 302, such as UNIX, LINUX, Microsoft Windows®, etc.

It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 304 may be operatively coupled to a communication interface 308 such that server system 302 is capable of communicating with computing device 102 or user device 104 (all shown in FIG. 1), and/or another server system. For example, communication interface 308 may receive data from user device 104 via the Internet or a mobile network.

Processor 304 may also be operatively coupled to a storage device 312, such as database 114 (shown in FIG. 1), via a storage interface 310. Storage device 312 may be any computer-operated hardware suitable for storing and/or retrieving data. In some embodiments, storage device 312 may be integrated in server system 302. For example, server system 302 may include one or more hard disk drives as storage device 312.

In other embodiments, storage device 312 may be external to server system 302 and may be accessed by a plurality of server systems. For example, storage device 312 may include multiple storage units such as hard disks or solid state disks in a redundant array of inexpensive disks (RAID) configuration. Storage device 312 may include a storage area network (SAN) and/or a network attached storage (NAS) system.

In some embodiments, processor 304 may be operatively coupled to storage device 312 via a storage interface 310. Storage interface 310 may be any component capable of providing processor 304 with access to storage device 312. Storage interface 310 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 304 with access to storage device 312.

Memory area 306 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer system.

### Method for Cross Platform Implementing Cloud-Based Applications

In some embodiments, an environment for implementing a cloud-based applications cross-platform may be provided. As illustrated in FIG. 6, the present invention may be utilized within a cross-platform linking algorithm and method to facilitate the accessibility and use of a use-specific application on various devices and in various operating system environments. A user of a device may engage or be engaged by an application having at least one operationally specific use, such as, for example, a video chat application. For example, if a user seeks to deploy an application for a video chat with a user of another device having a different operating system, then the present invention may access tools to allow for the same application to execute on each of the devices being used with the differing operating systems.

In an embodiment of the present invention, a query may be run to determine the requirements of the user which may include the type of application sought to be run and/or the capabilities and/or characteristics of the at least one device utilizing the application, for example. In addition, the UI/UX of the target application may be selected and mapped, through at least one cloud-based address to at least one NOODL object or NOODL system. Upon identification of the targeted NOODL code, at least a portion of the code may be uploaded to at least one cloud location accessible by the at least one device. The NOODL code may form a portion of a NOODL file which may include NOODL portions from any cloud accessible platform and may be named and designated to be unique to the at least one device and to the application sought to be utilized on or by the at least one device. An application platform, such as an app store, for example, may receive at least one identifying indication of the NOODL file and may allow the NOODL file to be loaded into at least one target application resident on the application platform. The application in communication with at least an aspect of the NOODL file may form a novel application compatible with the at least one device by having at least one set of instructions of the existing application affected by at least a portion of the NOODL file. The novel application may remain resident remotely from the at least one device, may be at least partially downloaded by the at least one device, and/or may be shared by at least two devices in part to drive at least some portion of shared communications between the devices.

### Asymmetric Key Base Sign-In Process

In some embodiments, a sign-in process for accessing the ECOS using asymmetric keys may be provided. The integrity of digital information as it passes between systems may be bolstered by using a digital signature such that a sender may use cryptographic algorithms to create a data structure that is associated with the information to be sent. A recipient with access to the information may cryptographically verify that the message hasn't been modified since the sender has signed it. In cases where the recipient doesn't have access to the same key used by the sender for verification, a digital signing scheme that uses asymmetric keys is useful. The sender can make the public portion of the key available to any recipient to verify the signature, but the sender may retain control over using the private portion of the key.

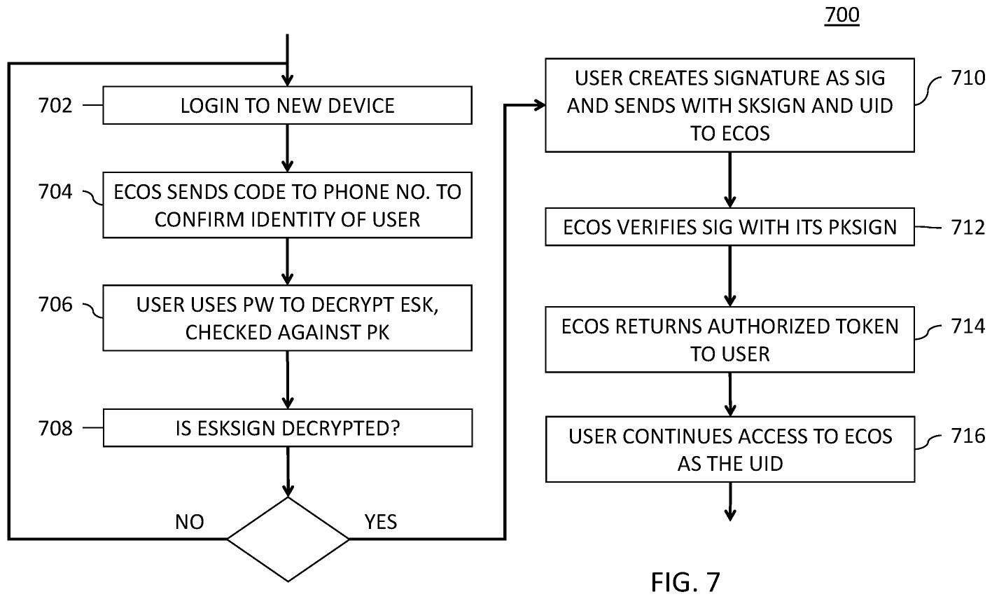

As illustrated in FIG. 7, the present invention provides for the ECOS system to send at least one code to a known user contact address, such as a mobile phone number, to confirm the identity or authorization of the login of the user of a first device in connection with an application in accordance with the present invention. If the authenticity of the user is confirmed, the system may decrypt the generated and encrypted signed key (ESK) which is verified against the public key (PK). If decryption fails to occur, the user may be required to login to their device once more and begin the process again.

Successful decryption of the ESK may allow the ECOS system to receive from the user an identifying signature (or an object indicative of an identifying signature) which may then be combined with the secret key (SK) and a system maintained user id to an aspect of the ECOS system to be verified. Upon verification, the ECOS system produces and returns an authorized token that is accessible by the user and may sent to the user to be resident on the user's local device which may be used to access and allow access by others to encrypted applications, information, and other areas controlled in the ECOS system. The user may or may not need to implement the authorized token to access some areas of the ECOS system which may be accessible through the use of the user's id.

### Doctor Registration Flow

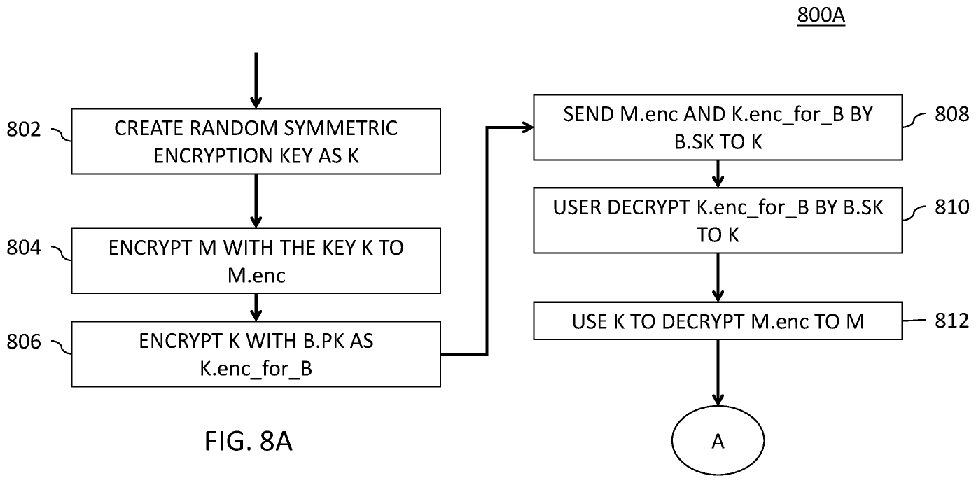

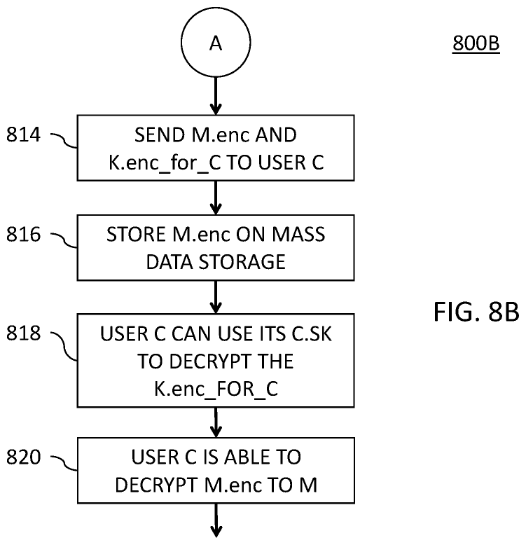

In an embodiment of the present invention, as illustrated in FIGS. 8A and 8B, single-key encrypted document sharing may occur amongst and between multiple participants of the ECOS system and related applications. Each user may have an asymmetric key pair, a PK and SK, wherein User A may share a message M with User B. First, a random symmetric encryption key (K) is generated which is then in turn used to encrypt the message M. The key K is itself then encrypted with a PK of user B and then sent with the encrypted message and the encrypted K. User B may then decrypt the received K using a SK and then ultimately use the K to decrypt the message M. As illustrated in FIG. 8B, following similar logic, either User A or User B is able to re-encrypt the K for a new User C with C.pk. These encryption techniques may be used in a number of ECOS-based applications and may, for example, be used to transfer and convey sensitive healthcare information.

By way of non-limiting example only, a user may access a doctor's advice through limited or a single action on an electronic device through an ECOS or NOODL supported infrastructure. Patients Health Information (PHI) is protected by the commonly known HIPAA laws in the United States. Providers of medical services, such as doctors and technicians, must use secure means to access such PHI electronically, regardless of how, for example, the PHI is stored or provided to the provider. This presents a complicated, costly and time/procedure consuming process which often limits or unnecessarily complicates the providers access to the PHI. Providing a direct and secure link to such PHI, on demand and in a near real-time manner, may help alleviate such obstacles.

In an embodiment of the present invention, an SMS text message, for example, with a time-limited web-link, may provide immediate access to the medical provider of PHI authorized for viewing or other access by the patient or user for a specific medical service. Such secure limitation to the PHI may allow a provider to see necessary patient medical information through a single action, such as by “one-click”, greatly speeding and simplify to provisioning of information to a provider by a patient or the patient's otherwise authorized agent and/or medical providers.

By way of non-limiting example only, a doctor's visit may be initiated by a patient and at least aspect of the PHI may be submitted by the patient. The patient may further select and authorize at least one licensed provider to further advise or consult on the exam or the PHI, for example. The patient may choose or have chosen a provider from at least one GUI interface providing information related to the provider, including the specialty and availability of the provider. Through the system of the present invention, a user may create login credentials and one or more unique web-link to allow providers to both to exam and review the at least some aspects of the PHI for the desired medical service(s) with predetermined limitation on access, such as a limitation on time. The system of the present invention may then send the user associated web-link to one or more of a provider which may allow the provider with “one click” access to, for example, a virtual exam room, the necessary PHI, and the patient, in a real time and immediate manner.

Authentication of users of the present invention may happen in various ways and at various points over the chain of communication points within the present invention such that each of a patient and/or provider may be required to authenticated themselves in the system at least once while in communication with some portion of the system. As would be appreciated by those skilled in the art, sign-in (check-in) to the system, such as access into an exam room, may be completed by a provider either at the time of check-in and allow the provider to access an “exam room” while waiting for a patient. As discussed herein, authentication may be multilevel and may include pre-authentication procedures, third-party verification, and/or the use of multifactor authentication techniques, for example.

In an embodiment of the present invention, a service provider may be able to pull out patient PHI by patient name, identification number, and/other credentials. In a situation where a provider may require the patient to provide PHI which has not been submitted to the system where the provider is able to access, the provider may request it of the patient through a secured link which may provide the information directly or, for example, simply provide authorization for access to the PHI is held by a third party, for example. To begin reviewing PHI and/or to enter an exam room space, for example, the provider may not need to engage with a sign-in process and may be authenticated and provided access through exactly one click on a link provided or other activation button correspondent to the present invention. In this way, for example, the provider may be able to see the patient and/or the PHI immediately while complying with rules such as HIPAA.

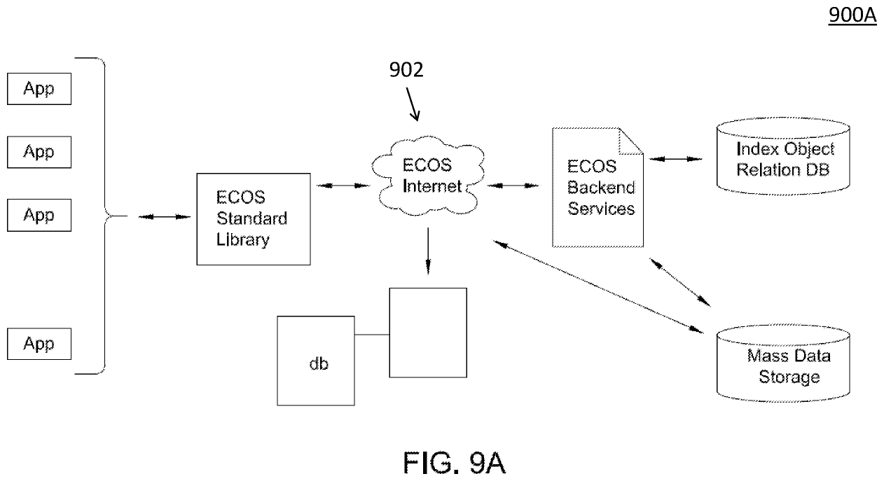

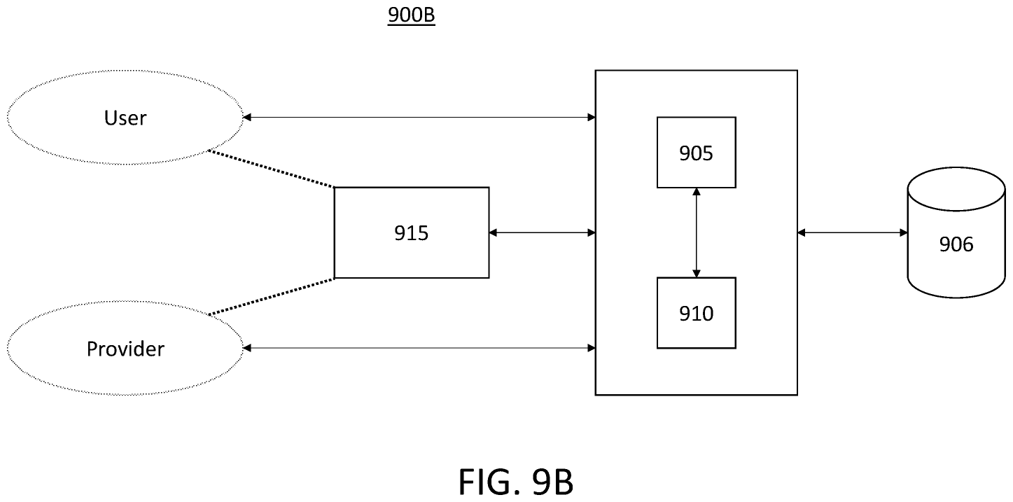

In an embodiment of the present invention as illustrated in FIG. 9B, system 900 may provide access to at least one PHI database 906 through application 901 by at least one user and one provider of the system. As discussed herein throughout, an app 901 may be resident and/or accessible by any device utilized by a user and/or provider and may be resident locally to the user of the app 901 or may be resident in a cloud accessible medium, such as through an AWS system, for example. The app 901 may provide a patient interface 905 and a provider interface 910. Although not shown, app 901, for example, may be partially resident locally on the user's device allowing for local access to at least a portion of patient interface 905. In this way, PHI located locally with the user may be accessible into system 900. PHI may also be aggregated and/or stored securely on database 906.

A user and a provider may also access a virtual exam room 915 which may be resident outside the app 901 and may include stand-alone security features. Authentication by either of the user and/or provider may be handled through app 901 and, more particularly, by patient interface 905 and provider interface 910, respectively. Each interface may pre-authenticate its respective user and may provide an on-demand access credential for use in the system for immediate access to aspects of system 900 such as, for example, exam room 915 and/or database 906. For example, a user may send a request to a provider to meet in exam room 915. Such a request may be provided by app 901 and may be authenticated by provider interface 910. The user may have selected a provider from a list of preferred providers associated with the user at interface 905, for example, with a link to an exam room 915 sent directly to the provider from app 901 and, more particularly, by interface 910. The authentication of the provider may be verified by the app 901 upon entrance into the exam room 915, for example, but the access to exam room 915 by the provider may be instant and through clicking or otherwise activating a simple URL link, for example.

Through exam room 915, the user and provider may interact either through any means, such as visual in a tele-medicine setting, for example, or over text and/or voice means. The interaction may also be limited to a voice call between those in the exam room 915 paired with the visual inspection of test results and/or other visual information pertinent to the user. PHI from database 906 maybe be shared by the user or fetched by a provider with user permissions into the exam room 915 and/or accessible in app 901 to be sufficiently used by both parties. Certain PHI may require certain functionality for view, such as x-ray results, for example, and may use embedded or third party applications through app 901 to be viewed by the provider and/or user.

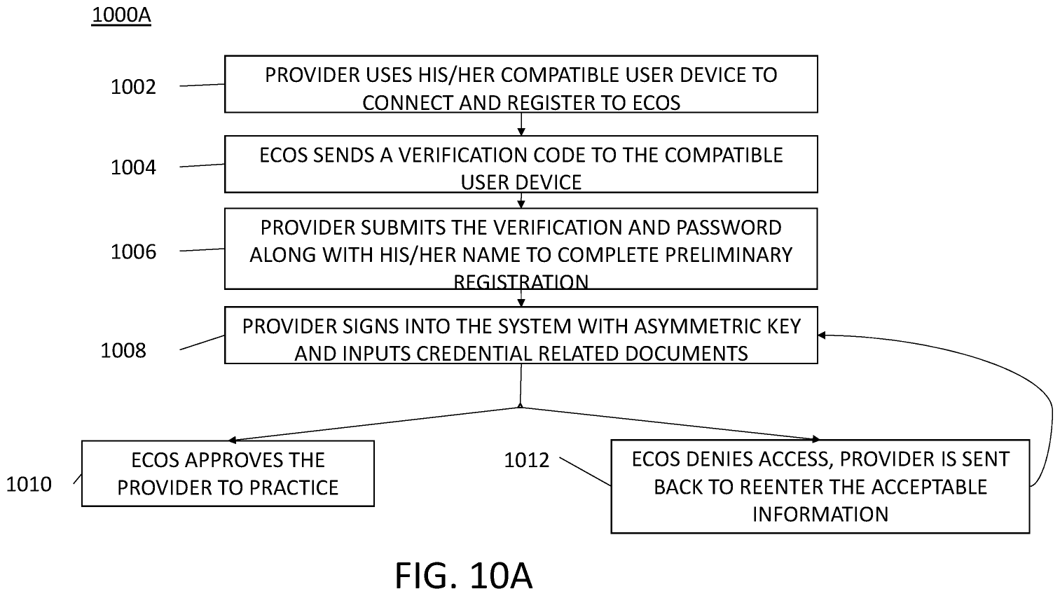

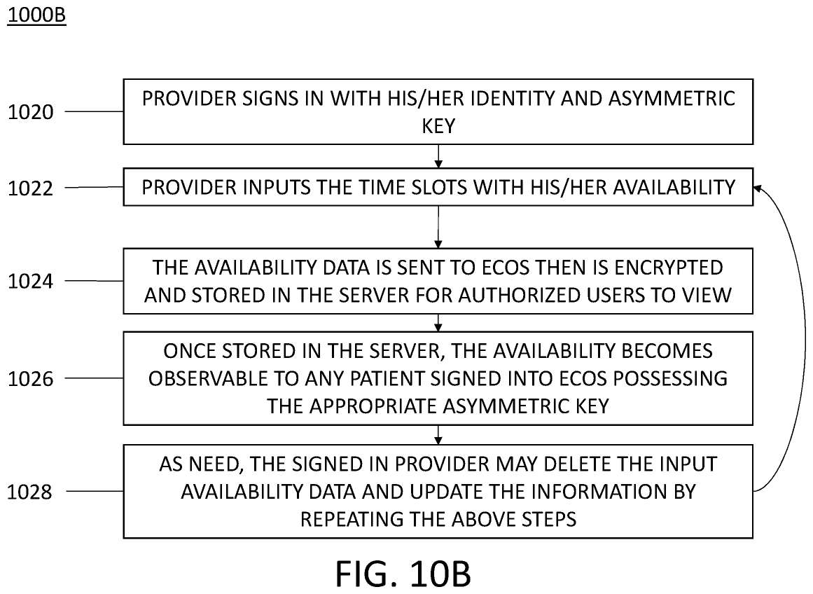

In an embodiment of the present invention, illustrated in FIG. 10A, through flowchart 1000A a provider, such as a doctor, medical professional, or medical institution, may register into the edge computing operating system (ECOS) computing system 100 utilizing a user device 104, including a compatible device including, but not limited to, a cellphone, computer, or tablet. Following step 1002, the provider may use the user device 104 to connect and register with ECOS computing system 100. Next in step 1004, the user device 104 is connected to ECOS computing system 100 and a verification code with be sent to the user device 104. In step 1006, the provider may use this submit the verification code with a password and his/her name to fill out the preliminary registration. In step 1008, the signed in provider may be assigned and sent an asymmetric key, and the provider may input information relating to his/her medical credentials and specialties. In some embodiments, the asymmetric key, or code, may be provided upon every log-in attempt, provided for a limited-time use (e.g., for 24 hours, for 72 hours, etc.) or it may be provided a single time and used until changed, either by the system or upon request by the user. In step 1010, the ECOS computing system 100 may approve the input information and store it in the memory or external database. The information will be available for any registered ECOS computing system user to view. In step 1012, if the entered credentials are denied by ECOS, the provider may be returned to step 1008 to reenter the appropriate credentials.

In an embodiment of the present invention, illustrated in FIG. 10B, through flow 1000B the provider may set up his or her schedule availability. In step 1020, the provider signs in with his/her identity and asymmetric key. In step 1022, the provider may input the time slots with his or her availability. In step 1024, the availability data is sent to ECOS computing system 100 for storage. In some embodiments, the availability data may be stored on a database, such as database 114 (shown in FIG. 1). Additionally, or alternatively, the availability data may be encrypted prior to storage of the availability data. In step 1026, the availability data may become observable to an authorized user in ECOS computing system 100 possessing the appropriate asymmetric key. In step 1028, the signed in provider may modify (e.g., delete) the input availability information and repeat the previous step to update and modify the availability data. In some embodiments, a provider's availability data may dynamically update, such as in response to a patient booking an appointment with a provider, or the like.

### Patient Registration Flow

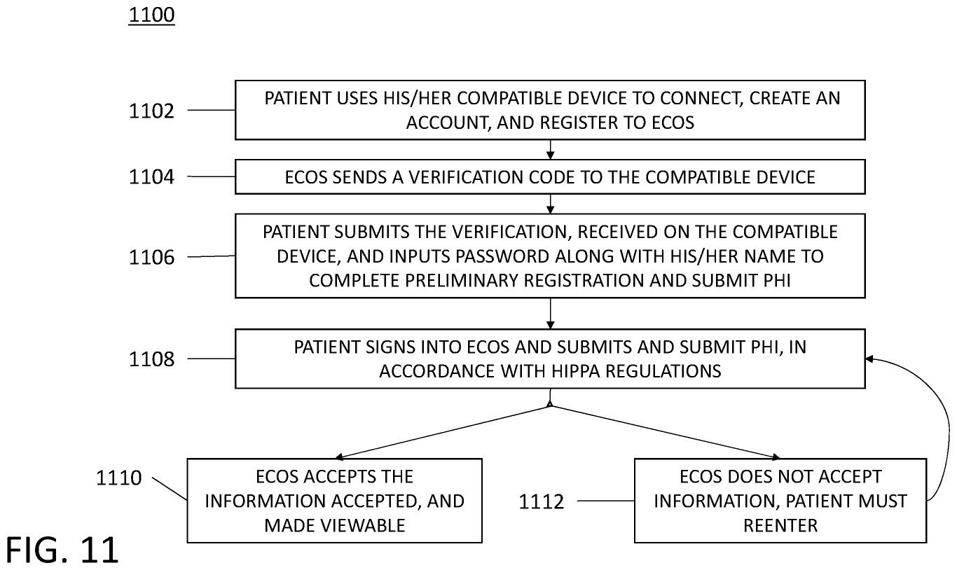

In another embodiment of the present invention, illustrated in FIG. 11, through flow 1100 a patient may register with a system, such as ECOS computing system 100 illustrated in FIG. 1. In step 1102, the patient may use a device, such as a user device 104, to connect, create an account, and register to ECOS. In Step 1104, ECOS computing system 100 sends a verification code to the user's device. The verification code may be sent over a network by way of a text message, an e-mail message, or the like, for example. In Step 1106 patient submits the verification code received on the user device 104 along with the input password for the created account along with his or her name to complete the preliminary registration. In step 1108, once registered, the patient may submit patient health information (PHI) in accordance with HIPPA regulations. In Step 1110, the ECOS computing system 100 may receive and accept the information allowing it to become viewable to any authorized or selected provider possessing the compatible asymmetric key. In Step 1112, ECOS computing system 100 receives and does not accept the submitted information; the patient may remain signed in, or sign in again, and attempt to input the information correctly. During registration, other types of information may be associated with a patient, such as health insurance information, preferred providers, preferred hospitals, or the like.

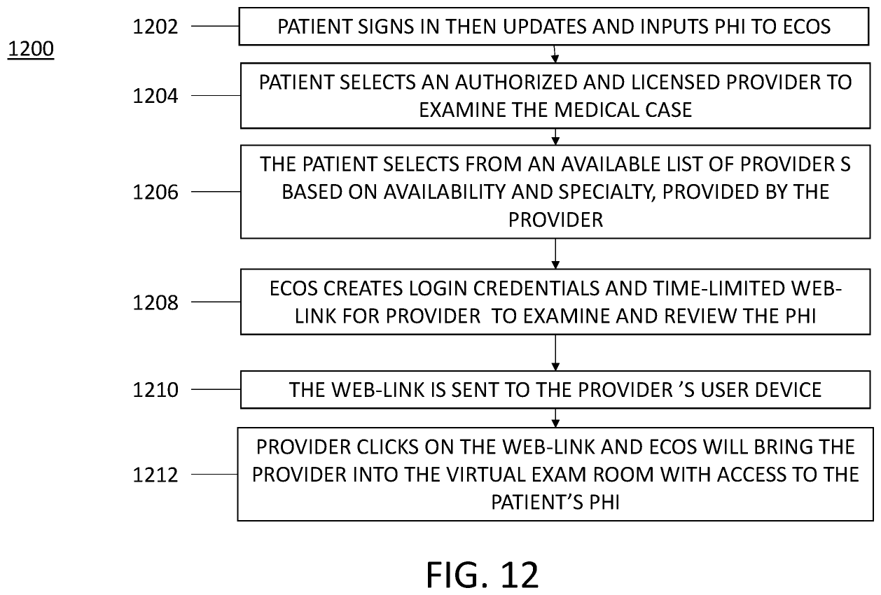

In another embodiment of the present invention, as illustrated in FIG. 12, through flow 1200 the patient may initiate the virtual visit with another, for example a health provider. In Step 1202, the patient signs in then updates and inputs PHI, such as to ECOS computing system 100 illustrated in FIG. 1. In step 1204, the patient may select an authorized and licensed provider to examine the medical case. In Step 1206, the patient may select from an available list of providers based on available time slots and specialty. In step 1208, once selection is made, ECOS computing system 100 may create login credentials and generate a web-link, such as a URL, for the provider to examine and review the PHI. In step 1210, the web-link is sent the provider's user device 104. In step 1212, the provider clicks on the web-link and ECOS computing system 100 will bring provider into the virtual exam room with access to the patient's PHI.

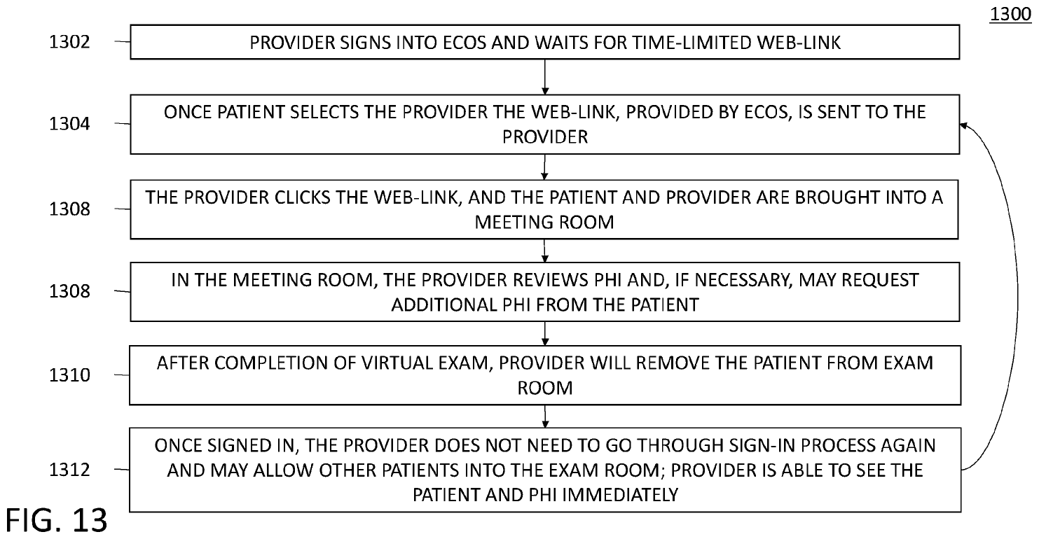

In an embodiment of the present invention, illustrated in FIG. 13, through flow 1300 a provider may initiate a virtual visit. In step 1302, a provider may sign into ECOS computing system 100 and wait for a time-limited web-link to be sent to his or her user device 104, such as via a text message or an e-mail, for example. The web-link may be generated by the ECOS in response to the patient selecting the provider, as described above in step 1206 of FIG. 12. In step 1304, the provider may click the ECOS computing system 100 provided time-limited web-link to be brought into a meeting room with the patient, wherein the meeting room is generated using one or more NOODLs applications, such as APP 1 or APP 2 of FIG. 1. The meeting room may be loaded using one or more NOODL files loaded from a library, such as the ECOS standard library 112, or the like. In some embodiments, the web-link may be time limited to prevent unauthorized access as the security is increased to protect PHI. In step 1306, in the meeting room, the provider may review the patient's PHI and, if necessary, may request additional PHI from the patient. In Step 1308, after completion of the virtual exam, the provider may remove the patient from the exam room. In Step 1310, the provider may remain signed into ECOS, avoiding the sign-in process, and may allow other patients to select them as the provider and the steps above repeat. All transmissions of PHI are complying with HIPPA regulations as the information is encrypted and only accessible to the authorized users.

### Overview for Virtual Meeting Process

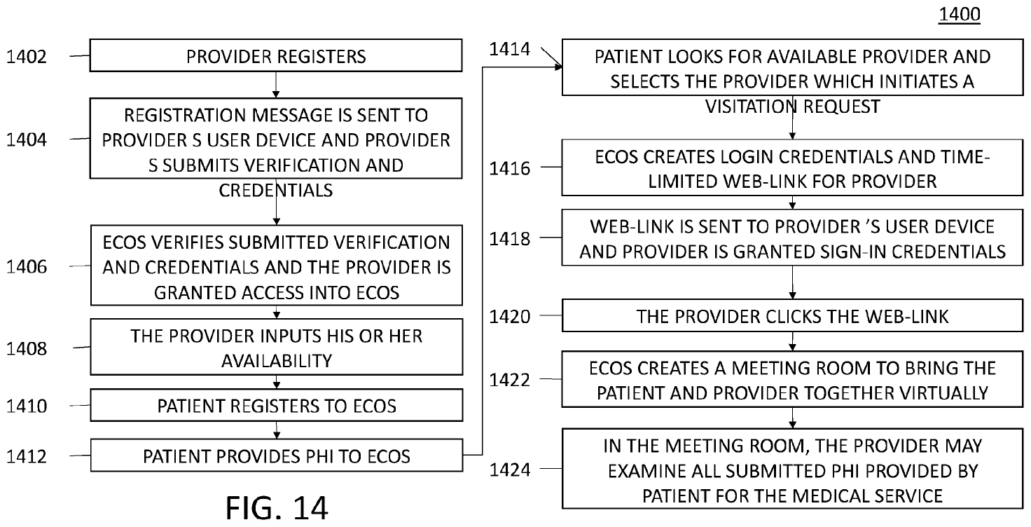

In an embodiment of the present invention, as illustrated in FIG. 14, flow 1400 provides an overview of a virtual meeting between multiple entities. Step 1402 may require a provider to register with a system, such as ECOS system 100 of FIG. 1. Registration may be performed using the process described above in FIG. 10A, flow 1000A. In step 1404, the registration message may be sent to the provider's device, such as user device 104, and the provider may submit his or her verification and credentials as outlined in steps 1004 and 1006, for example. In step 1406, ECOS computing system 100 verifies the submitted verification and credentials, and, if accepted, the provider is granted access into ECOS computing system 100 as seen in steps 1008 and 1010. Alternatively, if the verification or credentials are not accepted by ECOS computing system 100 the provider may be given the opportunity to resubmit the acceptable information. See step 1012. In step 1408, the provider, if granted access by ECOS, may input her or her availability as outlined by flow 1000B. In step 1410 the patient registers to ECOS computing system 100 as outlined by steps 1102, 1104, and 1106 of FIG. 11. In step 1412, the patient may submit PHI as outlined by steps 1108,1110, and 1112 of FIG. 11. In step 1414, the patient may select an available provider which initiates a virtual visitation request. Based on the needs of the virtual visitation, ECOS computing device 102 may load appropriate NOODL files to support the creation of a virtual exam room accessible to appropriate and approved entities (e.g., health care providers, patients, etc.). See steps 1204-1206. In step 1416, ECOS computing system 100 may generate login credentials and a time-limited web-link for the provider. See step 1208. In step 1418, the time-limited web-link is sent to the provider's user device 104 and the provider is granted the sign-in credentials. See step 1304. In step 1420, the provider may click the web-link; and in step 1422 ECOS computing system 100 creates a meeting room that brings the patient and provider together virtually. See step 1306. In step 1424, the provider may examine all the submitted PHI provided by the patient for the medical service. See step 1308. At the conclusion of the visit, the provider or patient may end the virtual meeting.

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. An edge computing operating system (ECOS) computing system, comprising:
a plurality of user devices;
a storage device configured to store one or more neuron organic object description language (NOODL) extension files;
an ECOS computing device comprising at least one processor in communication with a memory device, the at least one processor configured to:
receive, from one or more of the plurality of user devices, at least one user-defined data scheme and at least one attribute;
retrieve, from the storage device, at least one of the one or more NOODL extension files based, at least in part, on the at least one user-defined data scheme and the at least one attribute;
create at least one NOODL data object in accordance with ones of the NOODL extension files;
implement at least one application utilizing at least one aspect of the at least one loaded NOODL extension file or the at least one NOODL data object;
provide the one or more of the plurality of user devices access to the implemented application.

2. The ECOS computing system of claim 1, wherein the at least one application is a cloud-based application.

3. The ECOS computing system of claim 1, wherein at least one NOODL extension file generates a mapping of a computer application for at least one of the plurality of user devices based on the operating system of the at least one of the plurality of user devices.

4. The ECOS computing system of claim 1, wherein the at least one NOODL extension file connects UI/UX design with a frontend application, a backend data-model design, or a human-machine information exchange input-output.

5. The ECOS computing system of claim 1, wherein the at least one NOODL extension file uniforms HTML, CSS and Javascript at a high level of abstraction.

6. The ECOS computing system of claim 1, wherein implementation of the at least one application includes generation of a virtual exam room and transmission of an access link providing entry to the virtual exam room to at least one of the plurality of user devices.

7. The ECOS computing system of claim 6, wherein entry to the virtual exam room is granted in response to the at least one of the plurality of user devices providing a valid asymmetric key.

8. A non-transitory computer readable medium communicatively coupled to a processor, the medium comprising instructions that, when executed by the processor implement:
receiving, from one or more of a plurality of user devices, at least one user-defined data scheme and at least one attribute;
retrieving, from a storage device, at least one or more NOODL extension files based, at least in part, on the at least one user-defined data scheme and the at least one attribute;
creating at least one NOODL data object in accordance with ones of the NOODL extension files;
implementing at least one application utilizing at least one aspect of the at least one loaded NOODL extension file or the at least one NOODL data object; and
providing the one or more of the plurality of user devices access to the implemented application.

9. The non-transitory computer readable medium of claim 8, wherein the at least one application is a cloud-based application.

10. The non-transitory computer readable medium of claim 8, wherein at least one NOODL extension file generates a mapping of a computer application for at least one of the plurality of user devices based on the operating system of the at least one of the plurality of user devices.

11. The non-transitory computer readable medium of claim 8, wherein the at least one NOODL extension file connects UI/UX design with a frontend application, a backend data-model design, or a human-machine information exchange input-output.

12. The non-transitory computer readable medium of claim 8, wherein the at least one NOODL extension file uniforms HTML, CSS and Javascript at a high level of abstraction.

13. The non-transitory computer readable medium of claim 8, wherein implementation of the at least one application includes generation of a virtual exam room and transmission of an access link providing entry to the virtual exam room to at least one of the plurality of user devices.

14. The non-transitory computer readable medium of claim 13, wherein entry to the virtual exam room is granted in response to the at least one of the plurality of user devices providing a valid asymmetric key.

15. A method for providing cross-platform communications, the method, with at least one edge computing operating system (ECOS) device, comprising:
storing, on a storage device communicative-coupled to the ECOS device, one or more neuron organic object description language (NOODL) extension files;
receiving, from one or more of a plurality of user devices, at least one user-defined data scheme and at least one attribute;
retrieving, from the storage device, at least one of the one or more NOODL extension files based, at least in part, on the at least one user-defined data scheme and the at least one attribute;
creating at least one NOODL data object in accordance with ones of the NOODL extension files;
implementing at least one application utilizing at least one aspect of the at least one loaded NOODL extension file or the at least one NOODL data object;
providing the one or more of the plurality of user devices access to the implemented application.

16. The method of claim 15, wherein the at least one application is a cloud-based application.

17. The method claim 15, wherein at least one NOODL extension file generates a mapping of a computer application for at least one of the plurality of user devices based on the operating system of the at least one of the plurality of user devices.

18. The method of claim 15, wherein the at least one NOODL extension file connects UI/UX design with a frontend application, a backend data-model design, or a human-machine information exchange input-output.

19. The method of claim 15, wherein the at least one NOODL extension file uniforms HTML, CSS and Javascript at a high level of abstraction.

20. The method claim 15, wherein implementing of the at least one application includes generating of a virtual exam room and transmission of an access link providing entry to the virtual exam room to at least one of the plurality of user devices in response to the least one of the plurality of user devices providing a valid asymmetric key.
